(19) United States
(12) Patent Application Publication
(10) Pub. No.: US 2022/0363594 A1
(43) Pub. Date: Nov. 17, 2022

(54) OPTICAL FIBER MANUFACTURING METHOD AND OPTICAL FIBER MANUFACTURING APPARATUS

(71) Applicant: SUMITOMO ELECTRIC INDUSTRIES, LTD., Osaka (JP)

(72) Inventors: Yasuomi KANEUCHI, Osaka (JP); Satoshi YOSHIKAWA, Osaka (JP); Kazumasa OISHI, Osaka (JP)

(73) Assignee: SUMITOMO ELECTRIC INDUSTRIES, LTD., Osaka (JP)

(21) Appl. No.: 17/740,557

(22) Filed: May 10, 2022

(30) Foreign Application Priority Data
May 13, 2021 (JP) 2021-081828

(51) Int. Cl. C03C 25/105; C03B 37/03; C03C 25/18; C03B 37/025

(52) U.S. Cl. CPC C03C 25/105; C03B 37/032; C03C 25/18; C03B 37/025

(57) ABSTRACT

The optical fiber manufacturing method includes: a drawing step of drawing a glass fiber from an optical fiber base material with a melted tip; a passing step of passing the glass fiber through a fiber passage formed in a die; and a resin coating step of forming a resin layer on the outer periphery of the glass fiber by supplying a resin to the fiber passage through a flow path communicating with the fiber passage formed in the die. In the resin coating step, a temperature of the resin is controlled so that a supply pressure of the resin to the fiber passage becomes a value in a predetermined range.

### TECHNICAL FIELD

The present disclosure relates to an optical fiber manufacturing method and an optical fiber manufacturing apparatus.

The present application claims priority from Japanese Patent Application No. 2021-081828 filed on May 13, 2021, which is based on the contents and all of which are incorporated herein by reference in their entirety.

### BACKGROUND

International Publication WO 2008/139570 discloses an optical fiber manufacturing method. This optical fiber manufacturing method includes a drawing step and a resin coating step. In the drawing step, a tip of an optical fiber base material is melted and an optical fiber is drawn. In the resin coating step, the optical fiber is passed through a hole of a coating die and is coated with the resin in the hole to form a resin layer on the outer periphery of the optical fiber. Further, in the resin coating step, the resin is supplied to the coating die by a metering pump while a discharge amount of the metering pump is controlled so that the supply pressure of the resin to the hole becomes a predetermined value. In the resin coating step, the thickness of the resin layer is controlled by controlling the temperature of the optical fiber when the optical fiber enters the coating die in response to a fluctuation in the discharge amount of the metering pump.

### SUMMARY

An optical fiber manufacturing method according to an embodiment of the present disclosure includes: a drawing step of drawing a glass fiber from an optical fiber base material with a melted tip; a passing step of passing the glass fiber through a fiber passage formed in a die; and a resin coating step of forming a resin layer on the outer periphery of the glass fiber by continuously supplying a constant amount of a resin to the fiber passage through a flow path communicating with the fiber passage formed in the die, wherein in the resin coating step, a temperature of the resin is controlled so that a supply pressure of the resin to the fiber passage becomes a value in a predetermined range.

An optical fiber manufacturing apparatus according to an embodiment of the present disclosure includes: a die that includes a fiber passage through which a glass fiber passes downward in a vertical direction and a flow path which communicates with the fiber passage; a metering pump which supplies a resin to the fiber passage through the flow path of the die; a pressure detector which detects a supply pressure of the resin supplied from the metering pump to the fiber passage; a temperature controller which controls a temperature of the resin supplied from the metering pump to the fiber passage; and a control device which acquires the supply pressure detected by the pressure detector and controls the temperature of the resin controlled by the temperature controller in response to the value of the acquired supply pressure so that the value of the acquired supply pressure enters a predetermined range.

### BRIEF DESCRIPTION OF THE DRAWINGS

FIG. 1 is a diagram showing a configuration of an optical fiber manufacturing apparatus according to an example.

FIG. 2 is a schematic block diagram showing a resin coating device.

FIG. 3 is a schematic diagram showing a metering pump of the resin coating device.

FIG. 4 is a flowchart showing an optical fiber manufacturing method.

### DETAILED DESCRIPTION

### Problem to be Solved by Present Disclosure

In the technique associated with the optical fiber manufacturing method, since the thickness of the resin layer is controlled by controlling the discharge amount of the metering pump and the temperature of the optical fiber, there is a risk that the control of the entire apparatus will be complicated.

### Effect of Present Disclosure

An object of the present disclosure is to provide an optical fiber manufacturing method capable of simply controlling a thickness of a resin layer.

### Description of Embodiment of Present Disclosure

First, the contents of the embodiment of the present disclosure will be listed and described. An optical fiber manufacturing method according to an embodiment of the present disclosure includes: a drawing step of drawing a glass fiber from an optical fiber base material with a melted tip; a passing step of passing the glass fiber through a fiber passage formed in a die; and a resin coating step of forming a resin layer on the outer periphery of the glass fiber by supplying a resin to the fiber passage through a flow path communicating with the fiber passage formed in the die, wherein in the resin coating step, a temperature of the resin is controlled so that a supply pressure of the resin to the fiber passage becomes a value in a predetermined range.

In the optical fiber manufacturing method, when the drawn glass fiber passes through the fiber passage, the resin layer is formed on the outer periphery of the glass fiber by the resin supplied to the fiber passage. The thickness of the resin layer is controlled when the supply pressure of the resin is controlled to become the value in the predetermined range, but the supply pressure of the resin is controlled when the temperature of the resin is controlled. In this way, it is possible to easily control the thickness of the resin layer by controlling the temperature of the resin.

In the exemplary resin coating step, the supply pressure of the resin in the fiber passage may be acquired and the temperature of the resin may be controlled in response to the value of the acquired supply pressure. In this configuration, since the supply pressure of the resin is acquired, it is possible to control the supply pressure in a predetermined range with high accuracy.

In the exemplary resin coating step, a constant amount of the resin may be continuously supplied to the flow path by a metering pump. By using the metering pump, it is possible to easily and continuously supply a constant amount of the resin to the fiber passage.

An optical fiber manufacturing apparatus according to an embodiment includes: a die that includes a fiber passage through which a glass fiber passes downward in a vertical direction and a flow path which communicates with the fiber passage; a metering pump which supplies a resin to the fiber passage through the flow path of the die; a pressure detector which detects a supply pressure of the resin supplied from the metering pump to the fiber passage; a temperature controller which controls a temperature of the resin supplied from the metering pump to the fiber passage; and a control device which acquires the supply pressure detected by the pressure detector and controls the temperature of the resin controlled by the temperature controller in response to the value of the acquired supply pressure so that the value of the acquired supply pressure enters a predetermined range.

In the optical fiber manufacturing apparatus, when the drawn glass fiber passes through the fiber passage, the resin layer is formed on the outer periphery of the glass fiber by the resin supplied from the metering pump to the fiber passage. The thickness of the resin layer is controlled when the supply pressure detected by the pressure detector is controlled to enter the predetermined range, but the supply pressure of the resin is controlled by the control of the temperature controller controlling the temperature of the resin. In this way, it is possible to easily control the thickness of the resin layer by controlling the temperature of the resin.

The exemplary metering pump may be a uniaxial eccentric screw pump which includes a stator having a female thread-shaped inner wall and a male thread-shaped rotor rotatably fitted into the stator and transfers a constant amount of a resin by eccentrically rotating the rotor. In this configuration, it is possible to stably supply a constant amount of the resin regardless of the type of resin or the like.

### Details of Embodiment of Present Disclosure

A specific example of a coating device according to the present disclosure will be described below with reference to the drawings. Additionally, the present disclosure is not limited to these examples, is indicated by the scope of claims, and is intended to include all modifications within the meaning and scope equivalent to the scope of claims. In the following description, the same elements will be designated by the same reference numerals in the description of the drawings, and duplicate description will be omitted.

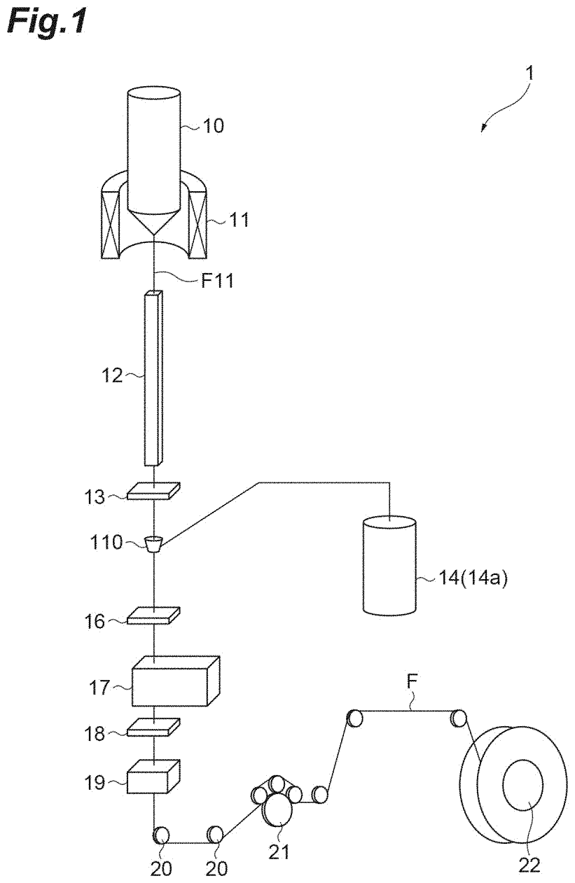

FIG. 1 shows a configuration of an exemplary optical fiber manufacturing apparatus 1. As shown in FIG. 1, an optical fiber manufacturing apparatus 1 is an apparatus for manufacturing an optical fiber F including a glass fiber F11 having a core and a clad and a coating resin and a drawing furnace 11, a forced cooling device 12, an outer diameter measuring instrument 13, a resin coating device 100, an uneven thickness measuring instrument 16, a UV furnace 17, an outer diameter measuring instrument 18, a bubble sensor 19, a guide roller 20, a capstan 21, and a winding bobbin 22 are provided in order along the passage path of the glass fiber F11 and the optical fiber F.

In the optical fiber manufacturing apparatus 1, the initial moving direction of the optical fiber F is set to the vertical direction and the moving direction of the optical fiber F is set to the horizontal direction or the inclined direction at the rear stage of a guide roller 20 below the bubble sensor 19. The drawing furnace 11 forms the glass fiber F11 having the core and the clad by drawing a preform (glass base material) 10 containing quartz glass as a main component. The drawing furnace 11 includes a heater which is disposed by interposing the preform 10 set inside the drawing furnace 11. The heater may surround the preform 10. The end portion of the preform 10 is melted and drawn by the heating of the heater to be the glass fiber F11. The drawn glass fiber F11 moves downward along the vertical direction.

The forced cooling device 12 cools the drawn glass fiber F11. The forced cooling device 12 has a sufficient length along the vertical direction in order to sufficiently cool the glass fiber F11. The forced cooling device 12 includes, for example, an intake port and an exhaust port (not shown) in order to cool the glass fiber F11 and cools the glass fiber F11 by introducing a cooling gas from this intake port.

The outer diameter measuring instrument 13 measures the outer diameter of the cooled glass fiber F11 after cooling. For example, the outer diameter measuring instrument 13 measures the outer diameter of the glass fiber F11 by irradiating the glass fiber F11 with light and taking an image of the light after passing through the glass fiber F11.

The resin coating device 100 coats the glass fiber F11 with a resin 14. The resin coating device 100 holds a liquid resin 14 which is cured by ultraviolet rays. In the resin coating device 100, the glass fiber F11 passes through the held resin 14 so that the surface of the glass fiber F11 is coated with the resin 14. Details of the resin coating device 100 will be described later.

The uneven thickness measuring instrument 16 measures the deviation of the center position of the glass fiber F11 with respect to the center position of the optical fiber F. In other words, the uneven thickness measuring instrument 16 measures the deviation of the resin used for coating on the peripheral surface of the glass fiber F11. For example, the uneven thickness measuring instrument 16 measures the center deviation by irradiating the optical fiber F with light and taking an image of the light after passing through the optical fiber F.

The UV furnace 17 is a resin curing portion which irradiates the resin 14 used for coating on the surface of the glass fiber F11 with ultraviolet rays to cure the resin 14. When the glass fiber F11 coated with the resin 14 on the surface passes through the UV furnace 17, the optical fiber F including the glass fiber F11 and the coating layer is formed.

The outer diameter measuring instrument 18 measures the outer diameter of the optical fiber F which is prepared by coating the glass fiber F11 with the resin 14. The outer diameter is measured by the same method as that for the outer diameter measuring instrument 13.

The bubble sensor 19 inspects the optical fiber F extending from the UV furnace 17 and detects bubbles and voids (hereinafter, referred to as bubbles or the like) generated in the glass fiber F11 or the coating resin. The bubble sensor 19 irradiates the optical fiber F with light and detects the presence of bubbles or the like by detecting the light scattered by the bubbles or the like.

The guide roller 20 guides the optical fiber F so that the optical fiber F moves along a predetermined direction. The moving direction of the optical fiber F is changed by the guide roller 20 and the optical fiber F is received by the capstan 21 and is sent to the winding bobbin 22. The winding bobbin 22 winds the completed optical fiber F.

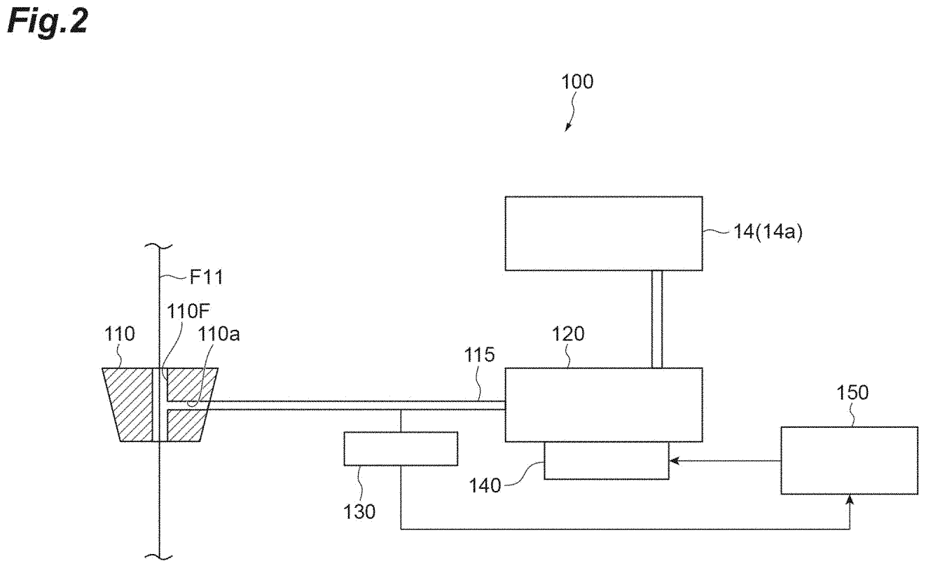

Next, the resin coating device 100 will be described in more detail. FIG. 2 is a schematic block diagram of the exemplary resin coating device 100. As shown in FIG. 2, the exemplary resin coating device 100 includes a die 110, a metering pump 120, a pressure detector 130, a temperature controller 140, and a control device 150. Additionally, in FIG. 2, the die 110 is schematically drawn as a vertical cross-section along the vertical direction.

As shown in FIG. 2, the die 110 includes a fiber passage 110F and a flow path 110a communicating with the fiber passage 110F. The fiber passage 110F has a columnar shape having an axis along the vertical direction and is formed from the upper surface to the lower surface of the die 110. That is, the fiber passage 110F penetrates the die 110 along the vertical direction. The fiber passage 110F is a portion through which the glass fiber F11 passes. Therefore, the diameter of the exemplary fiber passage 110F is larger than the diameter of the glass fiber F11 moving vertically downward through the outer diameter measuring instrument 13. The flow path 110a communicates the fiber passage 110F with the outer peripheral surface of the die 110. The exemplary flow path 110a may be a through-hole having a uniform flow path cross-sectional area. When the glass fiber F11 passes through the fiber passage 110F while the resin 14 flows from the flow path 110a into the fiber passage 110F, the peripheral surface of the glass fiber F11 is coated with a resin.

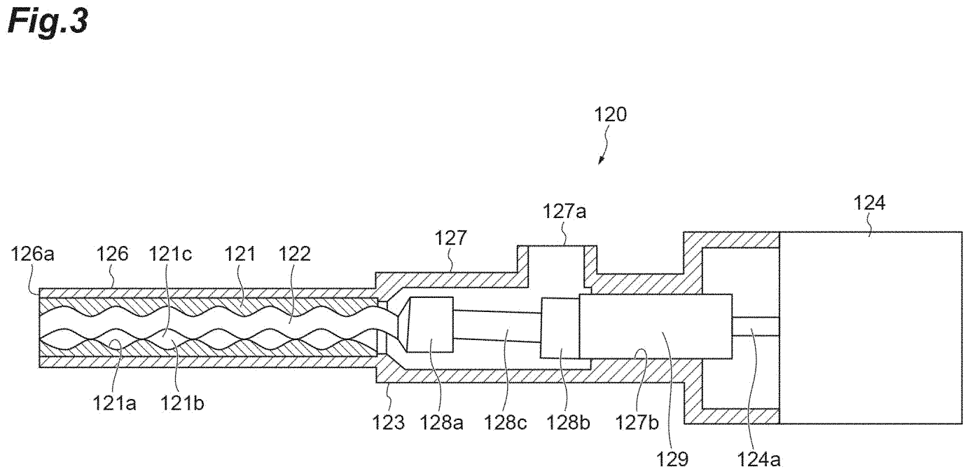

The metering pump 120 supplies a resin to the fiber passage 110F through the flow path of the die 110. FIG. 3 is a schematic cross-sectional view showing a cross-section of the metering pump 120. The metering pump 120 shown in the drawing is a so-called uniaxial eccentric screw pump. The exemplary metering pump 120 includes a stator 121, a rotor 122, a casing 123, and a motor 124. The stator 121 includes a female thread-shaped inner wall 121a. The inner wall 121a of the stator 121 has a shape of, for example, two female threads. The cross-section of an inner hole 121b formed by the inner wall 121a has a substantially oval shape (track shape) at any position in the longitudinal direction.

The rotor 122 has a shape of a single male thread and is rotatably fitted into the stator 121. The cross-section of the rotor 122 has a substantially perfect circular shape having the minor axis of the inner hole 121b as the diameter at any position in the longitudinal direction.

The casing 123 is a metallic cylindrical member and includes a first accommodating portion 126 and a second accommodating portion 127 which are adjacent to each other in the axial direction. The first accommodating portion 126 accommodates the stator 121 and the rotor 122 therein. The front end of the first accommodating portion 126 is formed as a discharge port 126a of the metering pump 120. The first accommodating portion 126 and the second accommodating portion 127 communicate with each other. A supply port 127a is formed at the second accommodating portion 127. This supply port 127a is connected to a resin tank 14a accommodating the resin 14.

The base end of the rotor 122 extends toward the second accommodating portion 127. The second accommodating portion 127 accommodates a pair of universal joints 128a and 128b and a shaft 128c connecting the universal joints 128a and 128b to each other. The universal joint 128a is connected to the base end of the rotor 122. The universal joint 128b is connected to a shaft 129. The shaft 129 is rotatably held by the wall portion 127b of the second accommodating portion 127. The base end of the shaft 129 is located on the outside of the second accommodating portion 127. Additionally, the wall portion 127b and the shaft 129 are sealed without a gap.

The motor 124 is fixed to the outside of the casing 123. A rotating shaft 124a of the motor 124 is connected to the base end of the shaft 129. When the rotating shaft 124a of the motor 124 rotates, the shaft 129 rotates and the rotor 122 connected by the universal joint 128b, the shaft 128c, and the universal joint 128a rotates eccentrically. When the rotor 122 rotates eccentrically in the inner hole 121b of the stator 121, a space (cavity) 121c formed by the rotor 122 and the inner hole 121b of the stator 121 moves along the axial direction. The cavity has a uniform cross-sectional area at any position in the longitudinal direction. Therefore, it is possible to continuously transfer (pressure feed) a set constant amount of fluid by the rotation of the rotor 122 in the metering pump 120. In the exemplary resin coating device 100, a constant amount of the resin 14 is continuously transferred by the metering pump 120.

The pressure detector 130 detects the supply pressure of the resin 14 supplied from the metering pump 120 to the fiber passage 110F. The pressure detector 130 is provided between the discharge port 126a of the metering pump 120 and the fiber passage 110F in the flow path of the resin 14 and on the downstream side of the temperature controller 140. In an example, the discharge port 126a of the metering pump 120 and the flow path 110a of the die 110 are connected to each other by a flow path 115. This flow path 115 may have a flow path cross-sectional area of the same size as that of the flow path 110a of the die 110. The exemplary flow path 115 can be formed by a pipe. The pressure detector 130 is provided to detect the pressure of the flow path 115 and detects the pressure of the resin 14 flowing in the flow path 115. The pressure detector 130 outputs the detected pressure of the resin 14 to the control device 150.

The temperature controller 140 controls the temperature of the resin 14 supplied from the metering pump 120 to the fiber passage 110F. The exemplary temperature controller 140 may include a heating element for heating the resin 14. The heating element may include, for example, a resistor that generates heat by electric power. The temperature controller 140 shown in the drawing is fixed to a casing 123 of the metering pump 120 and controls, for example, the temperature of the resin 14 supplied into the metering pump 120 through the casing 123.

The control device 150 controls the operation of the temperature controller 140. The control device 150 may include a computer including hardware such as a CPU, a RAM, a ROM, an input device, a wireless communication module, an auxiliary storage device, and an output device. The function of the control device 150 is realized by operating each component by a program or the like. For example, the control device 150 is communicably connected to the pressure detector 130 and the temperature controller 140. The control device 150 acquires a signal indicating the supply pressure detected by the pressure detector 130 from the pressure detector 130. Then, the control device 150 controls the temperature of the resin controlled by the temperature controller 140 in response to the value of the acquired supply pressure. The control device 150 controls the temperature controller 140 so that the value of the supply pressure of the resin enters a predetermined range by a so-called feedback control. For example, the control device 150 compares the acquired supply pressure with a set reference pressure and controls the operation of the temperature controller 140 on the basis of a comparison result.

The base ends of the flow path 115 and the flow path 110a for supplying the resin 14 to the fiber passage 110F are connected to the discharge port 126a of the metering pump 120 and the front ends thereof are connected to the fiber passage 110F. Since the flow path 115 and the flow path 110a of the resin 14 are not deformed, these will be simply described as a cylindrical flow path the length of the flow path is L and the radius is a. When the discharge amount of the resin 14 from the flow path 115 and the flow path 110a to the fiber passage 110F is Q, the supply pressure of the resin 14 of the fiber passage 110F is P2, the discharge pressure of the metering pump 120 is P1, and the viscosity is μ, Q is expressed by the following formula from Poiseuille's law.

Q=πa⁴ΔP/(8 μL) (1)

ΔP=P1−P2 (2)

Since L and a in the formula (1) are constants and the discharge pressure P1 of the metering pump 120 is also constant, the formula (1) is expressed by the following formula.

Q∝P2/μ (3)

As understood from the above formula (3), the resin discharge amount Q can be kept constant by controlling the viscosity μ in response to a fluctuation in the supply pressure P2 of the resin 14. Here, the viscosity μ fluctuates according to the temperature of the resin 14. Therefore, the resin discharge amount Q can be kept constant by controlling the viscosity μ while controlling the temperature of the resin 14 in response to a fluctuation in the supply pressure P2. Additionally, in the example of FIG. 2, the pressure detector 130 detecting the supply pressure P2 is provided in the flow path 115, but the pressure detector 130 is installed closer to the fiber passage 110F (for example, in the flow path 110a), and thus the supply pressure P2 can be detected more accurately.

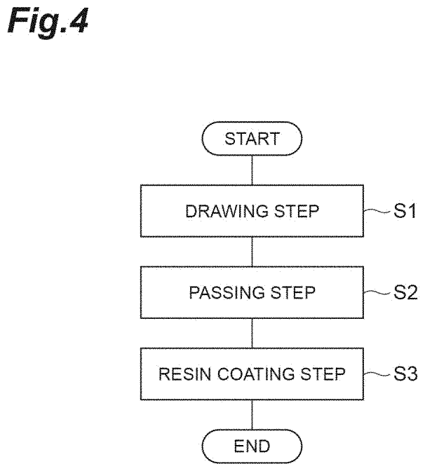

Next, the operation (optical fiber manufacturing method) of the optical fiber manufacturing apparatus 1 will be described. FIG. 4 is a flowchart showing the optical fiber manufacturing method. As shown in FIG. 4, the optical fiber manufacturing method includes a drawing step (step S1), a passing step (step S2), and a resin coating step (step S3).

In the drawing step, the glass fiber F11 is drawn from an optical fiber base material with a melted tip. In the exemplary optical fiber manufacturing apparatus 1, the preform 10 which is a base material is first set in the drawing furnace 11. Then, the preform 10 is melted by the heater. The melted preform 10 is drawn to form the glass fiber F11. The glass fiber F11 moves downward along the vertical direction and passes through the forced cooling device 12. In the forced cooling device 12, the drawn glass fiber F11 is cooled. The cooled glass fiber F11 passes through the outer diameter measuring instrument 13 and the outer diameter of the glass fiber F11 is measured.

The passing step is a step of passing the glass fiber F11 through the fiber passage 110F formed in the die 110. In this step, the glass fiber F11 of which the outer diameter is measured moves downward along the vertical direction and passes through the fiber passage 110F of the die 110. In the passing step, the moving speed of the glass fiber F11 is kept constant.

In the resin coating step, the resin 14 is supplied to the fiber passage 110F through the flow path 110a communicating with the fiber passage 110F formed in the die 110. When the glass fiber F11 passes through the resin 14 supplied to the fiber passage 110F, a resin layer is formed on the outer periphery of the glass fiber F11. As described above, the resin 14 supplied to the fiber passage 110F is sent from the metering pump 120 through the flow path 115. The resin amount discharged from the metering pump 120 per unit time can be determined on the basis of the speed at which the glass fiber F11 moves through the fiber passage 110F of the die 110 and the resin thickness of the resin 14 used for coating on the glass fiber F11. In the resin coating step, the discharge amount of the metering pump 120 is set so that a determined resin amount is supplied. That is, the metering pump 120 continuously supplies a constant amount of the resin 14 to the flow path 115. Additionally, the speed at which the glass fiber F11 moves through the fiber passage 110F of the die 110 may be set in the passing step.

In the resin coating step, the temperature of the resin 14 is controlled so that the supply pressure of the resin 14 to the fiber passage 110F becomes a value in a predetermined range. In an example, in the resin coating step, the pressure detector 130 detects the supply pressure P2 of the resin 14 to the fiber passage 110F and outputs a detection result to the control device 150. The control device 150 controls the temperature of the resin 14 in response to the value of the acquired supply pressure P2 by a so-called feedback control. That is, the control device 150 keeps the resin discharge amount to the fiber passage 110F constant by controlling the viscosity μ while controlling the temperature of the resin 14 in response to a fluctuation in the supply pressure P2 as described above. When the detected supply pressure P2 becomes higher than the reference pressure P, the control device 150 decreases the set temperature of the temperature controller 140 (or stops the operation thereof) so that the viscosity μ increases. Further, when the detected supply pressure P2 becomes lower than the reference pressure P, the control device 150 increases the set temperature of the temperature controller 140 so that the viscosity μ decreases. In this way, the control device 150 controls the temperature of the resin 14 in response to a fluctuation in the acquired supply pressure P2 so that the supply pressure P2 of the resin 14 to the fiber passage 110F enters a predetermined range.

In an example, the resin thickness is calculated on the basis of the measurement result of the outer diameter measuring instruments 13 and 18. In the resin coating step, the set temperature of the temperature controller 140 is determined so that this resin thickness becomes a desired size and the supply pressure P2 at that time is stored in the control device 150 as the reference pressure P. For example, when the supply pressure P2 fluctuates due to a change in the outside air temperature and the like, the control device 150 changes the set temperature of the temperature controller 140 in response to a fluctuation in the detected supply pressure P2. Further, when the viscosity μ of the resin changes as in the case in which the type of resin to be used changes, the set temperature of the temperature controller 140 is controlled so that the detected supply pressure P2 becomes the reference pressure P stored in the control device 150. Additionally, the fact that the supply pressure P2 becomes the reference pressure P may be that the supply pressure P2 enters a predetermined range including the value of the reference pressure P. For example, the temperature of the resin may be controlled so that the supply pressure P2 enters a range of about ±10% of the reference pressure P.

In the optical fiber manufacturing method, the center deviation of the glass fiber F11 with respect to the optical fiber F is measured by the uneven thickness measuring instrument 16 after the resin coating step. Then, the glass fiber F11 coated with the resin 14 moves downward along the vertical direction and passes through the UV furnace 17. When the glass fiber F11 passes through the UV furnace 17, the resin 14 is irradiated with ultraviolet rays to form the optical fiber F. The optical fiber F moves along a predetermined direction through the guide roller 20, is received by the capstan 21, and is sent to the winding bobbin 22.

As described above, the optical fiber manufacturing apparatus 1 according to an embodiment includes the die 110 that includes the fiber passage 110F through which the glass fiber passes downward in the vertical direction and the flow path which communicates with the fiber passage 110F, the metering pump 120 which supplies a resin to the fiber passage 110F through the flow path of the die 110, the pressure detector 130 which detects the supply pressure of the resin supplied from the metering pump 120 to the fiber passage 110F, the temperature controller 140 which controls the temperature of the resin supplied from the metering pump 120 to the fiber passage 110F, and the control device 150 which acquires the supply pressure detected by the pressure detector 130 and controls the temperature of the resin controlled by the temperature controller 140 in response to the value of the acquired supply pressure so that the value of the acquired supply pressure enters a predetermined range.

In the optical fiber manufacturing method using this optical fiber manufacturing apparatus 1, a resin layer is formed on the outer periphery of the glass fiber F11 by the resin 14 supplied to the fiber passage 110F when the drawn glass fiber F11 passes through the fiber passage 110F. The supply pressure P2 of the resin 14 is controlled to be a value in a predetermined range including the reference pressure P to control the thickness of the resin layer, but the supply pressure P2 of the resin 14 is controlled by controlling only the temperature of the resin 14. In this way, in the exemplary optical fiber manufacturing apparatus 1, it is possible to easily control the thickness of the resin layer by controlling the temperature of the resin 14.

In the exemplary resin coating step, the supply pressure P2 of the resin 14 in the fiber passage 110F is acquired and the temperature of the resin 14 is controlled in response to the value of the acquired supply pressure P2. Since this control is a so-called feedback control and the supply pressure P2 of the resin 14 is acquired, the supply pressure P2 can be adjusted within a predetermined range with high accuracy.

In the exemplary resin coating step, the metering pump 120 continuously supplies a constant amount of the resin 14 to the flow path 115. In this configuration, it is possible to easily and continuously supply a constant amount of the resin to the fiber passage by using the metering pump.

The exemplary metering pump 120 is a uniaxial eccentric screw pump which includes the stator 121 having the female thread-shaped inner wall 121a and the rotor 122 rotatably fitted into the stator 121 and having a shape of a male thread and transfers a constant amount of the resin 14 by eccentrically rotating the rotor 122. In this configuration, a constant amount of the resin can be stably supplied to the flow path 115 regardless of the type of resin and the like.

The present disclosure is not limited to the above-described embodiment and can be appropriately modified without departing from the spirit described in the claims.

For example, although a mechanism in which the glass fiber is coated with one type of resin has been described, the glass fiber may be coated with a plurality of types of resin. As an example, when the glass fiber is coated with two types of resin, two types of resin coating devices corresponding to each resin may be prepared.

What is claimed is:

1. An optical fiber manufacturing method comprising:
a drawing step of drawing a glass fiber from an optical fiber base material with a melted tip;
a passing step of passing the glass fiber through a fiber passage formed in a die; and
a resin coating step of forming a resin layer on an outer periphery of the glass fiber by continuously supplying a constant amount of a resin to the fiber passage through a flow path communicating with the fiber passage formed in the die,
wherein in the resin coating step, a temperature of the resin is controlled so that a supply pressure of the resin to the fiber passage becomes a value in a predetermined range.

2. The optical fiber manufacturing method according to claim 1,
wherein in the resin coating step, the supply pressure of the resin in the fiber passage is acquired and the temperature of the resin is controlled in response to the value of the acquired supply pressure.

3. The optical fiber manufacturing method according to claim 1,
wherein in the resin coating step, a constant amount of the resin is continuously supplied to the flow path by a metering pump.

4. An optical fiber manufacturing apparatus comprising:
a die that includes a fiber passage through which a glass fiber passes downward in a vertical direction and a flow path which communicates with the fiber passage;
a metering pump which continuously supplies a constant amount of a resin to the fiber passage through the flow path of the die;
a pressure detector which detects a supply pressure of the resin supplied from the metering pump to the fiber passage;
a temperature controller which controls a temperature of the resin supplied from the metering pump to the fiber passage; and
a control device which acquires the supply pressure detected by the pressure detector and controls the temperature of the resin controlled by the temperature controller in response to the value of the acquired supply pressure so that the value of the acquired supply pressure enters a predetermined range.

5. The optical fiber manufacturing apparatus according to claim 4,
wherein the metering pump is a uniaxial eccentric screw pump which includes a stator having a female thread-shaped inner wall and a male thread-shaped rotor rotatably fitted into the stator and transfers a constant amount of a resin by eccentrically rotating the rotor.
